(19) United States
(12) Patent Application Publication
(10) Pub. No.: US 2012/0216565 A1
(43) Pub. Date: Aug. 30, 2012

(54) METHOD OF PRODUCING CONSTANCY OF COMPRESSIVE STRESS IN GLASS IN AN ION EXCHANGE PROCESS

(76) Inventors: Douglas Clippinger Allan, Corning, NY (US); Kenneth Edward Hrdina, Horseheads, NY (US); William Rogers Rosch, Corning, NY (US)

(21) Appl. No.: 13/363,567

(22) Filed: Feb. 1, 2012

Related U.S. Application Data
(63) Continuation-in-part of application No. 13/034,118, filed on Feb. 24, 2011.

(51) Int. Cl. C03C 21/00

(52) U.S. Cl. 65/29.1; 65/30.14

(57) ABSTRACT

The present disclosure is directed to a method for producing constancy of the ion-exchanged product stress profile through adjustment of ion-exchange conditions by taking account of the influence of salt bath poisoning on the bath's useful lifetime. The present disclosure is directed to a method of ion-exchange in which the salt bath temperature and salt bath time are adjusted as a function of the amount of alkali metal ions that exchange in the bath. That is, temperature and time are adjusted as a function of salt bath poisoning. Temperature is set to its highest value and time to its shortest value in the starting un-poisoned salt bath, those values chosen to hit target values of surface compressive stress and exchange depth of layer. Temperature is then reduced and time lengthened as salt bath poisoning proceeds, those changes chosen to maintain the same surface compressive stress and exchange depth of layer.

### PRIORITY

This application is a continuation-in-part of U.S. patent application Ser. No. 13/034118 filed on Feb. 24, 2011, the content of which is relied upon and incorporated herein by reference in its entirety, and the benefit of priority under 35 U.S.C. §120 is hereby claimed.

### BACKGROUND

The process of ion-exchange to strengthen glass has been performed by various methods. In the ion-exchange process smaller cations in the glass, for example alkali metal ions such as lithium or sodium, are exchanged for larger cations such as sodium or potassium, respectively. One common method is the single ion-exchange process where a sheet of glass is placed in an ion-exchange or salt bath, for example, a potassium nitrate salt bath, at a constant temperature, for example, a selected temperature between 380-550° C., for a period of time in the range of 1 to 10 hours. After the exchange time is finished the glass is removed and washed to remove excess salt from the ion-exchange bath. A second method is a two-step method, for example, one as described in U.S. Pat. No. 3,798,013, in which the glass is placed in a first ion-exchange bath containing a first ion-exchange salt at a fixed temperature for a fixed time, and then the same glass is placed in a second ion-exchange bath tank with a second salt at a different salt concentration and at a fixed temperature for a fixed length of time. The second method has an advantage over the first method in saving time and extending the use of the salt bath, its life-time, but it does add complexity to the process. While these methods have been found commercially useful, they are open to further development, particularly with regard to extending the lifetime of the ion-exchange bath.

### SUMMARY

The present disclosure is directed to a method of producing consistency of compressive stress in glass in an ion-exchange process. The method optimizes the consistency of the ion-exchanged product compressive stress profile through adjustment of ion-exchange (“IOX”) conditions by taking account of the influence of salt bath poisoning (dilution of larger ion concentration by smaller ions that comes from the glass) on the bath's useful lifetime. The conventional method of strengthening glass uses a salt bath at a constant temperature where the glass is placed into the bath and held therein for a constant length of time. The glass thus obtained has a certain compressive stress and depth of layer that is dependent on such parameters as bath temperature, glass thickness, bath composition, time within the bath, glass composition and the fictive temperature of the glass. As the amount of cross sectional area of the glass processed increases, the salt becomes increasingly contaminated with the alkali metal ions that transfer from the glass to the salt bath. As a typical example, a fresh salt bath may be nominally 99.7 wt % KNO₃ and 0.3 wt % NaNO₃. The initial glass that is ion-exchanged in this fresh bath yields a compressive stress that is high, exceeding the specification by about 10-20%. As more glass is ion-exchanged in the same salt bath the salt will become increasingly enriched in sodium nitrate as the sodium is ion-exchanged out of the glass for potassium and comes out into the salt bath. The increased concentration of contaminants, in this case sodium, in the salt bath results in a drop of the compressive stress that is achieved in the glass. As more and more glass is ion-exchanged the compressive stress continues to drop until it no longer meets the specification. At this point the salt bath is dumped and replaced with a fresh salt bath. FIG. 1 is a graph illustrating a comparative example of this behavior using a single ion-exchange process for an exemplary glass containing sodium ions, for example without limitation, a sodium borosilicate or sodium aluminosilicate glass. In the example of FIG. 1, the use of a “fresh salt bath” for the targeted depth of layer (DOL) results in a compressive stress (CS) that exceeds the specification value, which is illustrated by the dashed line, by approximately 15% initially as is shown by the left side of the triangular area 10. As more and more glass area is processed in the salt bath, the process conditions, time and temperature, remaining the same, the compressive stress in the glass decreases due to the increase of Na in the salt bath. This change may occur over tens or hundreds of glass batches processed over a time period of weeks or months depending on the glass area per batch, volume of salt in the bath, and how much exchange of ions takes place during the process time and temperature. However, at some point the compressive stress in the glass decreases to a level that barely meets the customer specification and at this point the salt bath must be replaced with a fresh salt bath. In addition to exchanging larger alkali metal ions for smaller alkali metal ion, silver ions can also be ion-exchanged into the glass, using silver nitrate, AgNO₃.

The disclosure is directed to a method of ion-exchanging ions present in a glass, the method comprising the steps of providing a plurality of glass articles having alkali metal ions that are ion-exchangeable for larger alkali metal ions; providing an ion-exchange bath having alkali metal ions larger than the ion-exchangeable ions in the glass; providing a specification stating the depth-of-layer to which the glass is to be ion exchanged and the compressive stress that is to be imparted to the glass; heating the ion-exchange bath to a selected temperature; placing the glass in the bath and holding the glass in the bath for a selected time to exchange ions from the bath into the glass to the selected depth, and removing the glass articles from the bath; wherein as the plurality of glass articles are sequentially placed into and removed from the bath, the temperature of the bath increased (when starting with a fresh salt bath) and the time the articles are held in the bath is decreased in order to maintain the compressive stress in the glass to be consistent with the specification value+/−50 MPa, and maintain the depth-of layer to the specification value+/−5 μm. In one embodiment the temperature of the bath is increased and the time the articles are held in the bath is decreased in order to maintain the compressive stress in the glass to the specification value+/−30 MPa. In another embodiment the temperature of the bath is increased and the time the articles are held in the bath is decreased in order to maintain the compressive stress in the glass to the specification value+/−15 MPa. In a further embodiment the temperature of the bath is increased and the time the articles are held in the bath is decreased in order to maintain the compressive stress in the glass to the specification value+/−50 MPa, and maintain the depth of-layer to +/−3 μm. In an additional embodiment the glass is selected from the group consisting of a borosilicate, aluminosilicate, aluminoborosilicate glasses containing alkali metal ions, and soda lime glass.

### BRIEF DESCRIPTION OF DRAWINGS

FIG. 1 is a graph of compressive stress of the ion-exchanged glass versus the percent of processed area of glass that illustrates how the compressive stress changes over time, with the dashed line representing the specification's 100% compressive stress value.

FIG. 2 is a graph illustrating how changing the temperature where ion-exchange occurs results in a change in the loading time for a given ion-exchange process within a specific glass A for a constant depth-of-layer.

FIG. 3 is a graph illustrating how changing the temperature where ion-exchange occurs results in a change in the compressive stress for a given ion-exchange process within a specific glass A for a constant depth-of-layer.

FIG. 4 is a combination of the graphs of FIGS. 2 and 3, and FIG. 4 illustrates the impact of load temperature on both compressive stress and load time for a given ion-exchange process within a specific glass A for a constant depth-of-layer.

FIG. 5 is a graph illustrating the time that can be saved to yield a constant compressive stress value that meets the specification as a result of changing ion-exchange bath temperature and ion-exchange time for a given ion-exchange process within a specific glass A for a constant depth-of-layer.

FIG. 6 is a modeled graph of compressive stress as a percentage of the specification value as a function of multiple batches of glass (Batch number), where the large upswings in compressive stress occur when a salt bath has been replaced.

### DETAILED DESCRIPTION

Herein the term “standard process” means an ion-exchange process in which the exchange of smaller alkali metal ions in a glass for larger alkali metal ions to impart a compressive stress means that the ion-exchange is carried out at a constant temperature for a constant time over a sequence of glass sheets or batches of glass sheets being exchanged in the same salt bath. In addition, the phrase “consistency of compressive stress” as used herein means that the compressive stress imparted to the glass by the ion-exchange process of the present disclosure remains constant about the selected specification value, plus or minus (±) a megaPascals value as described herein. Compressive stress can be measured by commercially available surface stress meters, for example, the FSM-6000 (Orihara Corporation).

The present disclosure is directed to a method of ion-exchange in which the salt bath temperature and salt bath time are adjusted as a function of the amount of alkali metal ions that exchange in the bath. That is, temperature and time are adjusted as a function of salt bath poisoning. Poisoning refers to dilution of the larger ion concentration in the bath by the smaller ion that emerges from the glass during previous ion exchange in the same bath. For fresh (relatively un-poisoned or pure) salt, the salt bath temperature is increased to an extent that the surface compressive stress (“CS”) achieved in the glass just exceeds the required specification, while the time is accordingly reduced to achieve the target penetration or depth-of-layer (DOL″) to which the ions are exchanged. It is necessary to reduce the time when the temperature is increased in order to achieve a constant “diffusion depth” which is proportional to the square root of diffusivity times time, \sqrt{Dt}. The reason for this is that the diffusivity D is a strongly increasing function of temperature; a temperature increase of 40° C. can increase the diffusivity by more than a factor of 2. To maintain constant Dt it is necessary to reduce t when the temperature is raised. A typical increase in temperature over standard practice for a fresh salt bath is about 30° C. The temperature decrease is likely to be small, a fraction of a ° C. to a few ° C., for example, 0.05-5° C., to accommodate the amount of salt bath poisoning for any one batch of glass. However, as ion exchange proceeds with repeated glass batches processed in the same ion-exchange bath, the bath will become enriched in sodium and depleted in potassium, and by the time the salt poisoning reaches the level at which the standard process would produce a barely acceptable CS, the constant-CS process (this invention) would drop the process temperature back down to the standard process value. In similar fashion to the decrease of ion exchange time with the original increase in temperature that is used for a fresh salt bath, as the temperature is lowered to accompany salt bath poisoning the time is increased. By the time salt poisoning reaches the level at which the standard process would produce a barely acceptable CS, the constant-CS process would increase the time back up to the time used in the standard process. This again maintains a constant DOL.

In accordance with this disclosure, as the salt bath becomes enriched in the species that is ion-exchanged out of the glass, the salt bath temperature is lowered and the exchange time is increased such that the compressive stress of the glass does not significantly change, but stays at or just slightly above the compressive stress specification for the ion-exchanged glass being processed. Using this method the CS and DOL does not change significantly between batches of glass processed in the same salt bath. The temperature is lowered continually until the exchange time becomes too low to be economically beneficial. The rate at which the salt bath temperature is lowered can be either in a continual manner or in a stepwise manner, or as a combination of both techniques, depending on whichever form makes more sense in the specific manufacturing environment. This methodology has the advantage of decreasing the time needed for ion-exchanging using a fresh salt bath, which would greatly benefit a plant that is out of capacity and is seeking for more throughput. The process also has the advantage of extending the life of the salt bath for a plant that has excess capacity. In this case, the temperature is lowered in order to extend the life of the bath at the expense of taking more time to ion-exchange. The upper and lower process temperatures and the rate at which the temperature is lowered is dependent on the specifics of the ion-exchange including the glass type, anneal state of glass, thickness of glass, type of salt, quantity of salt in the tank and rate of throughput of the glass. This can be either empirically determined or modeled.

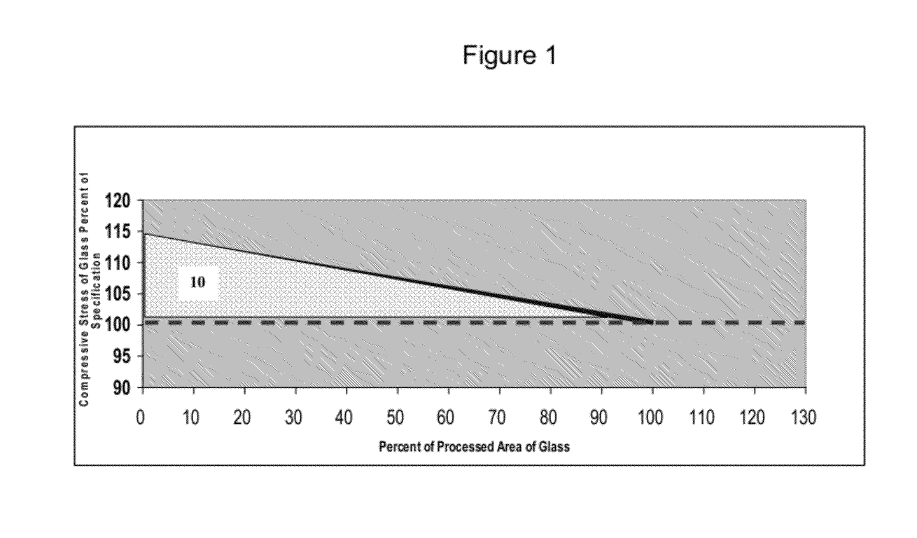

As an example of how to choose the rate of temperature reduction and time increase, a scaled-down experiment can be done to determine the rates. The volume of salt used in a commercial ion-exchange bath is scaled down to a small manageable value, for example, 1 kg, and the ion-exchange is carried out at a selected time and a selected temperature that are chosen to deliver the targeted DOL when starting with the nominally purest salt quality. A sequence of small test pieces of glass are run through the same bath at the same time and temperature conditions, and the CS and DOL are measured as a function of the accumulated area of glass treated. The result will resemble FIG. 1 which shows the CS diminishing smoothly and approximately linearly with area processed. Additional glass is processed in the same bath until the CS has diminished to the target value desired for the product. This provides a measure of how much glass area can be treated at the fixed time and temperature before the CS becomes too low. This area value is used at a later step. The experiment is then repeated using a fresh salt bath, raising the temperature and shortening the time, and running only a single sample before replacing the salt until a time and temperature are identified that give the desired DOL and also the target CS. This identifies the higher temperature and shorter time that are used to start the constant-CS process. Subsequently, one fits an exponential curve to the two times vs. processed area for (1) the initial (shorter) time that goes with initial (higher) temperature and (2) the final (standard process) time that goes with the standard process temperature, which is the time and temperature used in a commercial process. The second area point on the time or temperature curve vs. area is the area corresponding with the ion-exchanged area at which the CS has been reduced to the target value. The shape of the desired process time vs. accumulated area of glass processed is exponential, so this curve through the starting and ending points gives the constant-CS process time vs. area. Finally the temperature vs. accumulated area processed is given by a straight line through the initial (higher) temperature and the standard process temperature. Once again the second area point is that found above where CS was reduced to the target value in the standard process. When both the exponential curve for time and the linear curve for temperature are expressed in terms of accumulated area of glass processed, where the numbers come from a 1 kg salt bath experiment, that area can be rescaled by the ratio of production salt bath (say 1000 kg) to the experimental salt bath. This converts the experimental estimate for temperature and time to one appropriate to the production process. For example if the production salt bath contains 1000 kg of salt and the experimental one contains 1 kg of salt, then the production process can ion exchange 1000 times as much glass area before the time and temperature should be adjusted to stay on the exponential and linear curves given by the experiment. This is the same as scaling the experimental area axis in the time-vs.-area plot or the temperature-vs.-area plot by the ratio of production salt bath mass divided by experimental salt bath mass. It is here noted that that the production can be extended beyond the nominal cutoff at the nominal time and temperature because by continuing to decrease the temperature and lengthen the time appropriately, the CS (and DOL) are both maintained constant. Finally the salt bath is replaced when the time of processing is no longer economical or else the temperature becomes too low to keep the salt melted.

The following elaborates on the method and provides a more detailed explanation of how to choose the rate of temperature reduction and time increase using a scaled-down experiment to determine the rates. In this procedure the volume of salt used in a commercial ion-exchange bath is scaled down to a small, manageable value. The results obtained are directly transferable to a commercial process.
1. The procedure uses a scaled-down salt bath at some fraction of the production salt bath mass, for example, a 1 kg salt bath instead of 1000 kg salt bath as may be used commercially.
2. Start with a high purity salt of interest, for example without limitation, KNO₃. Start with the purest salt of interest, choose a nominal time, temperature, and glass thickness, and run a sequence of test pieces through same salt bath, one at a time, and record the CS and DOL vs. area of glass treated. The result will look like FIG. 1 except it will have real CS values vs. real area values. Continue treating small glass samples until the CS has dropped to the specification value below which further samples have unacceptably low CS. Note the area of glass treated at exactly the point where CS has reached its minimum allowed value, and call that area A₁. The time of ion exchange is denoted t₁ and the temperature T₁.
3. Replace the salt with fresh salt and ion exchange only one piece of glass at a time, always in fresh salt, and vary the time and temperature (typically raising the temperature and shortening the time relative to step 2) until the desired target CS and DOL are achieved. The (shorter) time of ion exchange is denoted t₀ and the (higher) temperature is denoted T₀.
4. Fit an exponential curve to the relations between process time and processed area in the form

$$t ( A ) = {t}_{0} exp [ ln ( \frac{{t}_{1}}{{t}_{0}} ) \frac{A}{{A}_{1}} ] = {{t}_{0} ( \frac{{t}_{1}}{{t}_{0}} )}^{A / {A}_{1}}$$

In this expression A is the area of processed glass, t is the inventive process time to maintain constant CS, and the other values were determined in steps 2 and 3. This expression is chosen to satisfy the two conditions t(A=0)=t₀ and t(A=A₁)=t₁. This says that for the initial conditions where no area has been processed yet (A=0, salt is fresh), the time of ion exchange is set to be t₀. This was defined in step 3. This expression shows how to reduce the time as a function of area treated until the treated area reaches is maximum value of A₁, at which point the ion exchange time is t₁. This was determined in step 2. One can continue reducing the temperature below the initial target of T₁ and lengthening the time beyond the initial target of t₁ to enable use of salt that would have been too poisoned in the conventional process based on (T₁, t₁), but at some point the time becomes inconveniently long or the temperature too low. Lowering the temperature below T₁ and lengthening the time beyond t₁ allows more glass to be processed before the need of replacing the salt with fresh salt at the cost of slowing down the throughput. The choice of whether this makes sense commercially depends on salt cost and throughput considerations.
5. The inventive processing temperature to maintain constant CS is given by the expression

$$T ( A ) = {T}_{0} + ( {T}_{1} - {T}_{0} ) \frac{A}{{A}_{1}} .$$

Here T is the temperature, A the area of processed glass, and the other constants were defined in steps 2 and 3. This expression gives T₀ as the processing temperature when area is 0 (freshest salt) as defined in step 3 above, and gives T₁ as the processing temperature at area A₁ as defined in step 2 above.
6. To treat a production salt bath of mass larger than the nominally 1 kg mass bath of the above procedure, simply rescale the area by the ratio of masses. Thus, in a salt bath of 1000 times the mass of the experimental bath, one may treat 1000 times as much glass area and stay on the same curve of time and temperature vs. treated area that was determined as explained above.

The present disclosure utilizes the observation that compressive stress imparted to a glass can exceed the specification by differing amounts depending on poisoning of the salt. Thus, in an ion-exchange process, products with different levels of performance can be made and shipped to a customer depending on, among other factors, the cross-sectional area of glass that has been processed. The present disclosure is directed to a process in which both the ion-exchanged glass's compressive stress and depth of layer do not change with poisoning of salt, but remain substantially constant and within specification. In the process disclosed herein the salt bath temperature and the time for ion-exchange to take place are changed with time of salt bath usage or equivalently with total area processed to yield a nearly constant compressive stress and depth of layer.

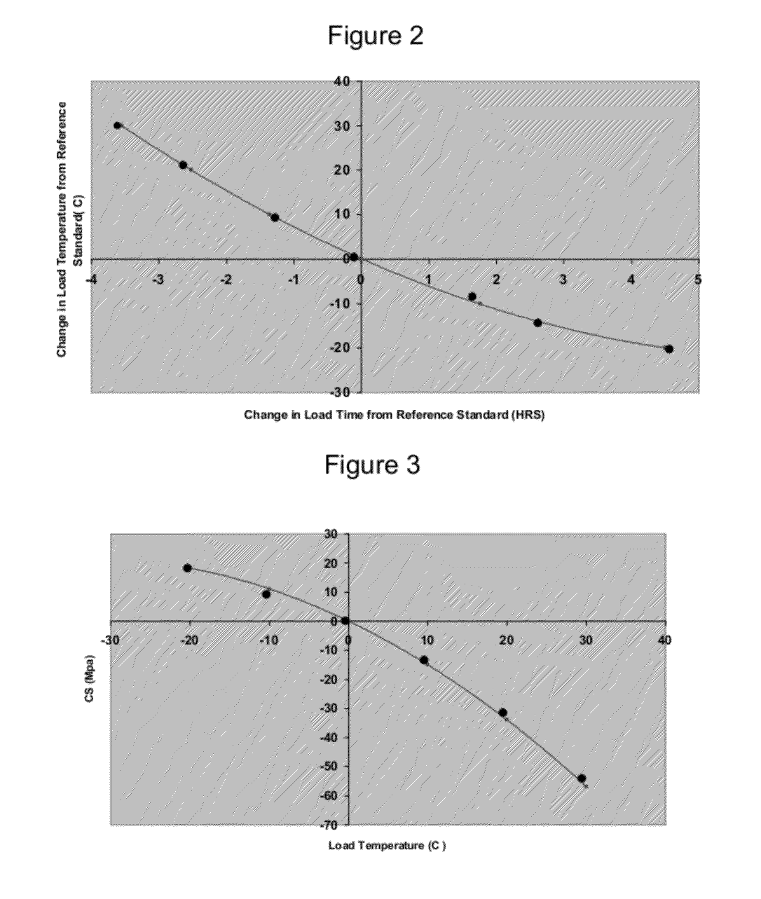

FIG. 2 is a graph illustrating the change in load temperature from Reference Standard temperature (° C.) versus the change in load time (hours (HRS)) from the Reference Standard where an exemplary ion-exchangeable glass, herein referred to as Glass A, has a constant DOL of approximately 45 μm after ion-exchange. The 0/0 point where the two axes cross is the reference condition. In the example of FIG. 2 the glass is ion-exchanged using the normal procedure of ion-exchange at constant temperature for a standard length of time. FIG. 2 shows that as the temperature in which ion-exchange takes place is changed away from the reference standard, the time needed for the ion-exchange to reach the same DOL also changes. In this particular example, a 10° C. increase in temperature results in the same depth of layer, but in approximately 1.4 hours shorter time then the standard ion-exchange process. A 10° C. cooler ion-exchange process requires approximately 1.8 hours more time than the standard process. The temperature difference primarily impacts the mutual diffusion of the ion-exchanging species. Lower temperatures result in slower diffusion and require longer times to reach the same DOL. Higher temperature results in faster diffusion and requires less time to reach the same DOL as the reference condition. Diffusion is an activated process such that its temperature dependence takes an exponential form. This is known as the Arrhenius temperature dependence.

The FIG. 2 graph indicates that loading at higher temperatures is desirable in order to speed up the ion-exchanging process. Unfortunately, the higher temperature loading for the same DOL results in a lower CS as is illustrated by the data presented in FIG. 3 which is a graph of CS in megaPascals (MPa) versus the Load Temperature (° C.). While the exact reason for the drop in CS with higher loading temperature is not necessarily known, it is hypothesized that the drop in CS with increased loading temperature is the result of relaxation of the structure that takes place during the ion-exchange process. This relaxation process, which is known in the literature on ion exchange for strengthening glass, can be thought of as a conversion of elastic strain from ion replacement to plastic strain as the structure accommodates the larger ions through permanent structural relaxation. The stress is only proportional to the elastic strain so the conversion to plastic strain lowers the stress. The temperature dependence of stress relaxation rate is also observed to have an Arrhenius dependence as does the diffusivity. The graph suggests that the rate at which stress relaxation occurs at higher temperatures is faster than the rate of increase of diffusion. Thus, using a higher temperature loading results in having a penalty in the CS of the glass. However, using a lower temperature, although taking longer, results in an increase of CS in the glass. This signifies that the CS can be increased by lowering the temperature during which ion-exchange takes place, and this may yield a benefit or cost savings by extending the life of the salt bath. This would particularly benefit a manufacturing plant which is not running at capacity. Salt bath life is extended as described by this disclosure by allowing a salt bath to be used at a higher level of poisoning, which would ordinarily cause the CS to fall below the target value, by lowering the temperature and reducing stress relaxation while simultaneously lengthening the time so that the DOL is maintained.

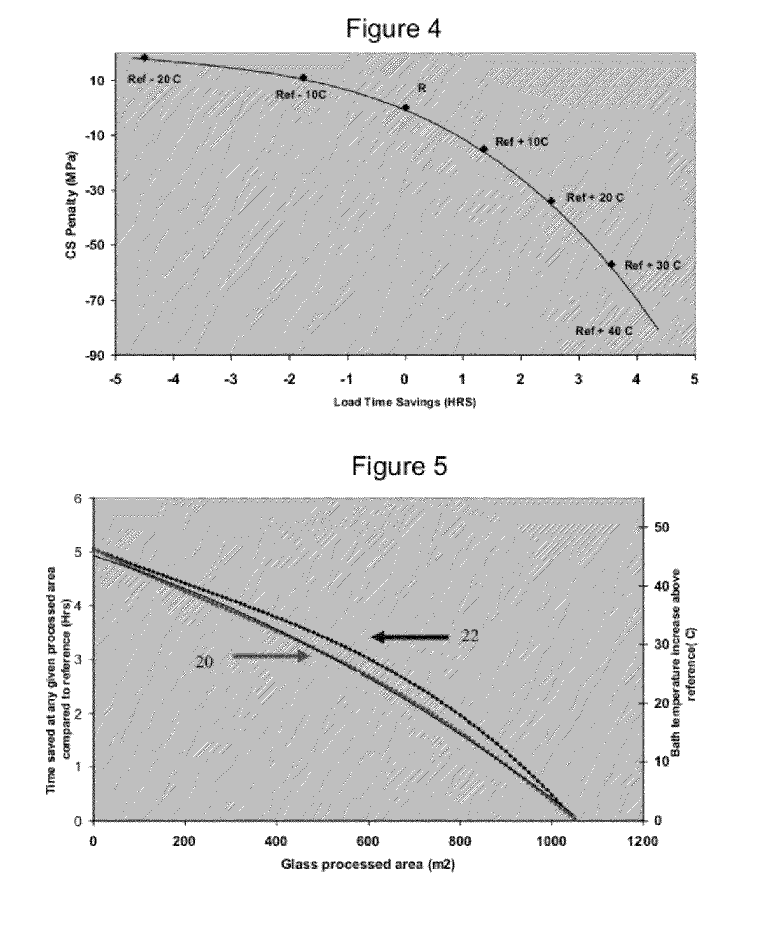

The data from FIGS. 2 and 3 were combined to create FIG. 4. FIG. 4 illustrates how the loading temperature influences both the load time and CS for Glass A at a constant DOL. For a fresh salt bath the glass has approximately 100 MPa excess CS (over specification) at the reference load temperature R. Hours of loading time can be saved by using higher temperatures, but at the expense of a drop in CS. For example, in FIG. 4, if the temperature is increased by 30° C. (R+30 in FIG. 4), the load penalty of CS drops to 57 MPa and results in a decrease in the load time of ˜3.5 hours. Conversely, a gain in CS can be obtained by loading at lower temperatures, but at the cost of extending the time during ion-exchange.

FIG. 5 is a graph illustrating the time that can be saved using the present invention producing a glass at constant CS by changing the temperature and ion-exchange time. FIG. 5 illustrates both (1) the time in hours saved at any given processed area compared to a reference time (left vertical axis) and (2) the bath temperature increase above a reference temperature in ° C. (right vertical axis) versus the glass area processed in square meters (m²). The reference glass was Glass A and the DOL was kept constant in the glass. The total process time per area of glass processed that can be saved using the method described herein can be as much as 50% as is shown by FIG. 5 arrows 20 and 22. The illustrated time savings of approximately 50%, as shown by arrows 20 and 22, means that the throughput can be increased by a factor of 2 before the salt bath must be replaced. In FIG. 5 curve 20 represents the rightmost y-axis which is the bath temperature increase above the reference temperature and curve 22 represents the leftmost y-axis which is the time saved for any given process condition compared to the reference time for the reference process.

It was previously noted that FIG. 1 illustrates that the glass initially produced using a fresh ion-exchange has a CS that exceeds specifications. FIG. 1 also illustrates that the CS changes with the amount of glass that has undergone ion-exchange in the same salt bath. The present invention identifies a process by which faster load times can be accomplished while maintaining a constant CS. It shows that, in this case, the ion-exchange process can be run in such a way as to yield the same CS, even as the salt becomes contaminated with more NaNO₃, which benefits the manufacturer because the salt bath does not have to be replaced as frequently. This invention also identifies loading time savings as a second benefit to a constant CS. The ion-exchange process can be done, on average, in half the time as the reference process which provides a second benefit.

The process according to the present disclosure was found to have the following advantages over the standard process of ion-exchange at constant temperature and constant time. In one embodiment the process described herein produces a glass whose surface compressive stress CS is maintained constant to within ±50 MPa of the specification value regardless of salt bath age (i.e. purity) while also maintaining the DOL constant to within ±−5 microns of the specification value. In another embodiment the CS is maintained constant to within ±30 MPa of the specification value regardless of salt bath age (i.e. purity) while also maintaining the DOL constant to within ±5 microns of the specification value. In a further embodiment CS is maintained constant to within ±15 MPa of the specification value regardless of salt bath age (i.e. purity) while also maintaining the DOL constant to within ±5 microns of the specification value. In additional embodiments of the foregoing the DOL is maintained constant to within ±3 μm of the specification value.

In one aspect where sodium is the principal ion being exchanged for a larger ion, for example potassium, the process produces a glass whose material property CS is maintained constant to within ±50 MPa of the specification value while also maintaining the DOL constant to within ±5 microns of the specification regardless of the amount of sodium contamination within the bath. In another embodiment where sodium is the principal ion being exchanged for a larger ion, for example potassium, the process produces a glass whose material property CS is maintained constant, to within ±30 MPa of the specification value while also maintaining the DOL constant to within ±5 μm of the specification value regardless of the amount of sodium contamination within the bath. In another embodiment where sodium is the principal ion being exchanged for a larger ion, for example potassium, the process produces a glass whose material property CS is maintained constant to within ±50 MPa of the specification value while also maintaining the DOL constant to within ±5 μm of the specification value regardless of the amount of sodium contamination within the bath. In additional embodiments of the foregoing the DOL is maintained constant to within ±3 μm. The sodium content level, in weight percent (wt %), as impurity in the bath can be in the range of 0.005 wt % to 10 wt % determined as NaNO₃.

Another advantage of the method disclosed herein is that glass can be processed at a faster ion-exchange rate; hence manufacturing throughput can be increased. In one aspect using the method described herein, the average ion-exchange process is shortened by a factor of 1.5× to 5× relative to that of a standard process of using constant temperature and constant time for ion-exchange. That is, the time is shortened to a time in the range of t=(standard time)÷1.5 to t=(standard time)÷5. In one embodiment the average ion-exchange process is less than three hours for a single batch of glass. In another embodiment the individual ion-exchange time is shortened to a time in the range of 0.75 hour to 6 hours. In a further embodiment the salt bath life is extended by lowering the temperature to less then 400° C.

The method described herein involving lowering the temperature at which ion-exchange is carried out can be done either in a continuously decreasing temperature regime or in a step-wise but controlled manner such that ion-exchanged glass being removed maintains constant CS and DOL from batch to batch in the same salt bath regardless of age of the salt bath. As the temperature is decreased the residence time of the glass batch in the salt bath is increased. In the controlled step-wise method the temperature is lowered and the exchange time is increased either after each batch is processed through the salt bath, or, in one embodiment, at times during the processing of each bath of glass.

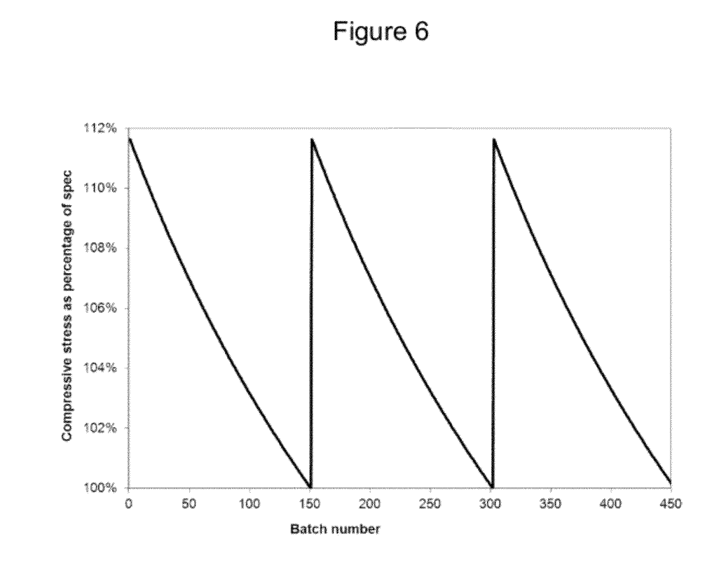

As has been indicated above, the temperature/time program can be determined either empirically or by modeling. FIG. 6 is a modeled graph of compressive stress as a percentage of the specification value as a function of multiple batches of glass (Batch number), where the large upswings in compressive stress occur when a salt bath has been replaced. This graph shows the feature “too much compressive stress imparted to the glass when a fresh salt bath starts up” that this disclosure exploits. The present disclosure takes the saw tooth shape and makes it flat through manipulation of time and temperature as a function of batch number. The present disclosure thus significantly reduces these variations and the extra process window to achieve an overall speed-up of the process or an increased utilization of the salt in the bath. That is, an increased percentage of the salt in a fresh bath is utilized or ion-exchanged before the bath must be replaced. This lowers processing costs and increases efficiency and throughput.

The disclosure is thus directed to a method of ion-exchanging ions present in a glass article, the method comprising the steps of:

providing a glass article having smaller alkali metal ions that are ion-exchangeable for larger alkali metal ions,

providing an ion-exchange bath having alkali metal ions larger than the ion-exchangeable ions in the glass,

providing a specification stating the depth-of-layer to which the glass is to be ion-exchanged and the compressive stress that is to be imparted to the glass,

heating the ion-exchange bath to a selected temperature,

placing the glass article in the bath and holding the glass article in the bath for a selected time to exchange ions from the bath into the glass to a selected depth, and

removing the glass article from the bath;

wherein as glass articles are repeatedly placed into and removed from the bath, the temperature of the bath is sequentially decreased and the time the articles are held in the bath is sequentially increased in order to maintain the compressive stress in the glass constant to specification value±50 MPa, and maintain the depth-of layer to the specification value±5 μm.

When the bath is fresh or un-poisoned the temperature is set to its highest value and the time to its shortest value to initialize the process, these values chosen to achieve the target compressive stress and depth of layer.

The temperature of the bath is decreased and the time the articles are held in the bath is increased from the initial values in order to maintain the compressive stress in the glass to the specification value±30 MPa.

In a further aspect the temperature of the bath is decreased and the time the articles are held in the bath is increased from the initial values in order to maintain the compressive stress in the glass to the specification value±15 MPa.

In an additional aspect the temperature of the bath is decreased and the time the articles are held in the bath is increased relative to the initial values in order to maintain the compressive stress in the glass to the specification value+/−50 MPa, and maintain the depth of-layer to +/−3 μm.

The glass being ion-exchanged is selected from the group consisting of borosilicate, aluminosilicate, aluminoborosilicate glasses containing alkali metal ions, and soda lime glass.

The predetermined schedule is obtained by:

(a) providing a specification setting a target value for the compressive stress and depth-of-layer of a glass article undergoing ion-exchange;

ion-exchanging a glass piece using a fresh salt bath for a selected time and at selected temperature that are chosen to deliver the targeted compressive stress and depth-of-layer when starting with a bath containing of the nominally purest salt quality;

processing a sequence of test pieces of glass through the same bath at the selected time and temperature conditions;

measuring the compressive stress of the test pieces as a function of the accumulated area of glass treated, and continuing processing glass articles until the compressive stress has diminished to the target value set by the specification to thereby provide a measure of how much glass area can be treated before the compressive stress becomes too low; and

(b) providing a second fresh salt bath, heating the bath to a temperature above the selected temperature in (a) and ion-exchanging one glass piece for a shorter time than at the selected temperature in (a), and determining the compressive stress and depth of layer as a function of processed glass area; and

(c) repeating (b) a plurality of times, using a fresh salt bath and a new piece of glass, at different temperatures and times and determining the compressive stress and depth of layer as a function of processed area until a time and temperature are identified that provides the target compressive stress and depth-of-layer;

fitting an exponential curve to the time versus processed area for (1) the shorter time that goes with the higher initial temperature and (2) the final time in (a) before the compressive stress becomes too low.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A method of ion-exchanging ions present in a glass article, the method comprising the steps of:
providing a glass article having smaller alkali metal ions that are ion-exchangeable for larger alkali metal ions,
providing an ion-exchange bath having alkali metal ions larger than the ion-exchangeable ions in the glass,
providing a specification stating the depth-of-layer to which the glass is to be ion exchanged and the compressive stress that is to be imparted to the glass,
heating the ion-exchange bath to a selected temperature,
placing the glass article in the bath and holding the glass in the bath for a selected time to exchange ions from the bath into glass to a selected depth, and removing the glass articles from the bath; and
removing the glass article from the bath and replacing it with another glass article;
wherein as glass articles are repeatedly placed into and removed from the bath, the temperature of the bath is sequentially decreased and the time the articles are held in the bath is sequentially increased in order to maintain the compressive stress in the glass constant to specification value±50 MPa, and maintain the depth-of layer to the specification value±5 μm.

2. The method according to claim 1, wherein when the bath is fresh or un-poisoned the temperature is set to its highest value and the time to its shortest value to initialize the process, these values chosen to achieve the target compressive stress and depth of layer.

3. The method according to claim 1, wherein the temperature of the bath is decreased and the time the glass article is held in the bath is increased from the initial values in order to maintain the compressive stress in the glass to the specification value±30 MPa.

4. The method according to claim 1, wherein the temperature of the bath is decreased and the time the glass article is held in the bath is increased from the initial values in order to maintain the compressive stress in the glass to the specification value±15 MPa.

5. The method according to claim 1, wherein the temperature of the bath is decreased and the time the article is held in the bath is increased relative to the initial values in order to maintain the compressive stress in the glass to the specification value+/−50 MPa, and maintain the depth of-layer to +/−3 μm.

6. The method according to claim 1, wherein the glass is selected from the group consisting of borosilicate, aluminosilicate, aluminoborosilicate glasses containing alkali metal ions, and soda lime glass.

7. The method according to claim 1, wherein the predetermined schedule is obtained by:
(a) providing a specification setting a target value for the compressive stress and depth-of-layer of a glass article undergoing ion-exchange;
ion-exchanging a glass piece using a fresh salt bath for a selected time and at selected temperature that are chosen to deliver the targeted compressive stress and depth-of-layer when starting with a bath containing of the nominally purest salt quality;
processing a sequence of test pieces of glass through the same bath at the selected time and temperature conditions;
measuring the compressive stress of the test pieces as a function of the accumulated area of glass treated, and continuing processing glass articles until the compressive stress has diminished to the target value set by the specification to thereby provide a measure of how much glass area can be treated before the compressive stress becomes too low; and
(b) providing a second fresh salt bath, heating the bath to a temperature above the selected temperature in (a) and ion-exchanging one glass piece for a shorter time than the selected temperature in (a), and determining the compressive stress and depth of layer as a function of processed glass area; and
(c) repeating (b) a plurality of times, using a fresh salt bath and a new piece of glass, at different temperatures and times and determining the compressive stress and depth of layer as a function of processed area until a time and temperature are identified the provides the target compressive stress and depth-of-layer;
fitting an exponential curve to the time versus processed area for (1) the shorter time that goes with the higher initial temperature and (2) the final time in (a) before the compressive stress becomes too low.
